(19) United States
(12) Patent Application Publication
(10) Pub. No.: US 2026/0028444 A1
(43) Pub. Date: Jan. 29, 2026

(54) RECYCLING POLYOLS PRODUCED FROM SEAT COVER MATERIALS

(71) Applicant: FAURECIA Sièges d'Automobile, NANTERRE (FR)

(72) Inventors: Anne-Sophie CABOUILLET, BOISSY-LE-SEC (FR); Florence FLAIG, ALTKIRCH (FR); Marc LAUTH, STRASBOURG (FR)

(21) Appl. No.: 18/867,704

(22) PCT Filed: May 17, 2023
(86) PCT No.: PCT/FR2023/050710

§ 371 Date: Sep. 29, 2025

(30) Foreign Application Priority Data
May 23, 2022 (FR) FR2204936

(51) Int. Cl. C08G 18/08; C08G 18/18; C08G 18/20; C08G 18/32; C08G 18/40; C08G 18/48; C08G 18/66; C08G 101/00; C08J 11/24

(52) U.S. Cl. CPC C08G 18/14; C08G 18/0838; C08G 18/1833; C08G 18/2063; C08G 18/3275; C08G 18/3281; C08G 18/4018; C08G 18/4829; C08G 18/6688; C08J 11/24; C08G 2101/00; C08G 2110/0083; C08J 2367/02; C08J 2375/04

(57) ABSTRACT

The present application relates to a method for producing a molded recycled polyurethane foam for a seat element, from seat cover material.

### TECHNICAL FIELD

The present disclosure relates to polyurethane foams for motor vehicle seats. In particular, the present disclosure relates to the recycling of seat cover materials to form new polyurethane foams.

### PRIOR ART

The synthesis of polyurethane materials (rigid and flexible foams, elastomers, adhesives, etc.) is based on the polyaddition reaction between a polyol, such as a polyphenol, and a polyisocyanate compound. A polyol must have specific properties to be used in the manufacture of polyurethane materials. For example, a polyol intended for the manufacture of a molded polyurethane foam for motor vehicle seats preferably has a viscosity at 25° C. of between 800 mPa·s and 1200 mPa·s, a hydroxyl number of between 26 mg (KOH)·g⁻¹ and 35 mg (KOH)·g⁻¹ and a water content of less than 0.1%. Indeed, a polyol with such a high viscosity is liquid and mixes easily with the polyisocyanate compound and any additives during conventional polyurethane foam production at room temperature or in a mold heated to between 50 and 75° C. In addition, the above hydroxyl value range enables a cross-linked three-dimensional network to be obtained, giving the foam, among other things, mechanical properties suitable for use in a motor vehicle seat.

Polyols and polyisocyanate compounds are petrochemical polymers whose production generates large quantities of CO₂. To reduce dependence on oil, and also cut CO₂ emissions, it is necessary to use polyols and polyisocyanate compounds of non-petrochemical or recycled origin.

Motor vehicle seat covers typically comprise a polyethylene terephthalate or polyamide charmeuse, a polyethylene terephthalate appearance material and a polyurethane block foam slit between the charmeuse and the appearance material.

At present, materials for motor vehicle seat covers at the end of their useful life or cut up during production are incinerated or landfilled, so they are not recycled. However, they represent an alternative source to petroleum for the production of polyols, which can then be used to produce molded recycled polyurethane foams for seats, creating a virtuous circle for the recycling of these materials.

However, it is not easy to produce a polyol with the properties required for the production of polyurethane seat foam from cover materials, as cover materials are complex materials made up of different types of material: polyethylene terephthalate-based textiles, polyamide-based textiles and polyurethane foam. Indeed, to produce a recycled molded polyurethane foam with comfort properties that meets the requirements of motor vehicle seats, it is necessary for the depolymerization of the cover materials to enable very precise cutting of the materials' structure to produce small molecules comprising hydroxyl groups capable of subsequently reacting with isocyanates. It is to the inventors' credit that they have found a method that meets this need.

### SUMMARY

A method is proposed for the production of a recycled polyurethane foam, in particular for seats, mattresses or sofas, more particularly for seats in vehicles such as automobiles or aircraft, for furniture seats, still more particularly for motor vehicle seat headrests, for lateral retention of a motor vehicle seat, said method comprising the following steps:
a) glycolysis treatment of a seat cover material, in particular for motor vehicle seats, aircraft seats, upholstery seats, to obtain a liquid polyol mixture, and
b) bringing the liquid mixture of polyols, a polyol, a surfactant, a polyisocyanate compound and optionally an additive into contact to produce the recycled polyurethane foam,
wherein the seat cover material is selected from polyester, polyurethane foam, polyethylene terephthalate, polyamide and mixtures thereof,
characterized in that
the mass ratio of liquid mixture of polyols: polyol in step b) is greater than or equal to 1:99 and less than 40:60, in particular between 10:90 and 30:70, most particularly between 15:85 and 20:80, and
the surfactant is chosen from an anionic surfactant, a cationic surfactant, a zwitterionic surfactant, a nonionic surfactant and mixtures thereof, more particularly from a nonionic surfactant.

During step a) of glycolysis treatment, which is a conventional step known to the person skilled in the art, the seat cover material will depolymerize to form the liquid mixture of polyols. The polyols in this liquid mixture are then reacted with the polyisocyanate compound in step b) of the method of the present invention to produce recycled polyurethane foam, in particular seat foam, which can comprise up to 6% by weight of cover material.

However, the inventors have found that the liquid mixture of polyols cannot be used as such in step b) due to its very high hydroxyl value. In fact, this hydroxyl index increases the hardness of the foams produced, reduces the open cell content of the foam and increases its shrinkage. Foams produced with a high-number hydroxyl polyol are therefore not suitable for motor vehicle seats.

Without being bound by any theory, the inventors are of the opinion that this high hydroxyl number is due to the use of the cover material in step a). Glycolysis of cover material, in particular polyethylene terephthalate and polyamide, leads to the production of polyols with a high hydroxyl value.

On the other hand, the introduction of polyols obtained by depolymerizing cover materials into molded seat foam formulations disrupts the foaming method by destabilizing the foam, which collapses during the molding process. Without being bound by any theory, the inventors are of the opinion that this destabilizing effect is due to the use of the cover material in step a), as it contains pollutants such as sizing oils, dyes, and fillers that can disrupt foaming processes.

It is to the inventors' credit that they have found that using the polyol and surfactant in step b) of the method of the invention solves these problems.

Thus, thanks to steps a) and b), the method of the present invention creates a virtuous circle of recycling a significant quantity of cover material, which is not normally recycled.

Thanks to this virtuous circle, the method of the present invention makes it possible to reduce the pollution generated by the incineration of these materials, and to reduce the environmental impact and the quantity of CO₂ produced by the polyurethane seat foam production chain.

The method of the present invention also makes it possible to reduce and limit the volatility of the production costs of polyurethane seat foam, by limiting the amount of polyols of petroleum origin incorporated into this foam.

Furthermore, the molded foam produced by the method of the present invention has a foam rise profile that is comparable to the rise profile of an industrial foam produced from a petrochemical polyol and commonly used in seats. Thus, the foam produced by the method of the present invention can be used in a seat element and does not require modification of the conventional industrial method for producing polyurethane foam.

According to another aspect, a polyurethane foam is proposed, in particular for seats, mattresses or sofas, more particularly for seats in vehicles such as cars or aircraft, for furniture seats, obtainable by the method of the present invention.

### BRIEF DESCRIPTION OF THE DRAWINGS

Other features, details and advantages will become apparent on reading the following detailed description and the analysis of the appended drawings, wherein:

FIG. 1

[FIG. 1] shows a rise profile of foams according to the invention (liquid mixture of polyols: polyol mass ratio of 20:80 and liquid mixture of polyols: polyol mass ratio of 30:70) and comparative foams (Reference).

FIG. 2

[FIG. 2] shows different photos of foams according to the invention and comparative foams.

### DESCRIPTION OF THE EMBODIMENTS

A method is proposed for the production of a recycled polyurethane foam, in particular for seats, mattresses or sofas, more particularly for seats in vehicles such as motor vehicles or aircraft, for furniture seats, still more particularly for motor vehicle seat headrests, for lateral retention of a motor vehicle seat, comprising the following steps:
a) glycolysis treatment of a seat cover material, in particular for motor vehicle seats, aircraft seats, upholstery seats, to obtain a liquid polyol mixture, and
b) bringing the liquid mixture of polyols, a polyol, a surfactant, a polyisocyanate compound and optionally an additive into contact to produce the recycled polyurethane foam,
wherein the seat cover material is selected from polyester, polyurethane foam, polyethylene terephthalate, polyamide and mixtures thereof, characterized in that
the mass ratio of liquid mixture of polyols: polyol in step b) is greater than or equal to 1:99 and less than 40:60, in particular between 10:90 and 30:70, most particularly between 15:85 and 20:80, and
the surfactant is chosen from an anionic surfactant, a cationic surfactant, a zwitterionic surfactant, a nonionic surfactant and mixtures thereof, more particularly from a nonionic surfactant.

For the purposes of the present invention, the term “foam” as used, for example, in the expression “polyurethane foam”, designates a compound with a three-dimensional cellular structure of the expanded type. The foam can be rigid or flexible, open-cell or closed-cell.

For the purposes of the present invention, “seat foam” means a foam whose mechanical properties are suitable for a seat element, in particular a motor vehicle seat element, an aircraft seat element, or a seat element for furniture.

For the purposes of this invention, “seat element” means a headrest, armrest, side part and combinations thereof.

For the purposes of this invention, the term “seat cover” refers to an element covering the padding of a seat.

According to the invention, the seat cover material is selected from polyurethane foam, polyethylene terephthalate, polyamide and mixtures thereof, Typically, the polyethylene terephthalate can be derived from the appearance material of the seat cover and/or the charmeuse, the polyamide can be derived from the charmeuse and the polyurethane foam can be the foam between the appearance material and the charmeuse.

Typically, the seat cover material can come from all or part of the cover, a waste product from the production of the cover, a waste product from the cutting of the cover, a waste product from the end-of-life of a motor vehicle seat, or combinations thereof.

The step a) of glucolysis treatment is a conventional step known to the person skilled in the art. It is described, for example, in: The chemical recycling of polyurethane (review), Behrendt & Naber, Journal of the University of Chemical Technology and Metallurgy, 44, 1, 2009, 3-23 (January 2009). The person skilled in the art will know how to use it to obtain a liquid mixture of polyols, in particular the liquid mixture of polyols with the following properties:
a hydroxyl value of between 200 mg (KOH)·g⁻¹ and 700 mg (KOH)·g⁻¹, more particularly between 300 mg (KOH)·g⁻¹ and 500 mg (KOH)·g⁻¹, and
a viscosity at 25° C. of between 500 mPa·s and 5000 mPa·s, more particularly between 750 mPa·s and 2000 mPa·s, even more particularly between 1000 mPa·s and 1500 mPa·s.

For the purposes of this invention, “viscosity” means Brookfield viscosity and/or viscosity measured by a cone-plane viscometer at 25° C.

The viscosity of the liquid mixture of polyols facilitates its use in step b). It is advantageously liquid at 25° C. and mixes easily with the polyol, surfactant, polyisocyanate compound and any additive in step b) to produce the polyurethane foam.

For the purposes of this invention, “hydroxyl value” means the content of free hydroxyl groups in a chemical substance expressed in milligrams of potassium hydroxide equivalent to the hydroxyl content of one gram of the chemical substance.

The use of the seat cover material in step a) results in a liquid mixture of polyols with a high hydroxyl value, in particular a hydroxyl value within the above ranges.

This high value does not allow the liquid mixture of polyols to be used, as such, in step b) of the method of the present invention.

The inventors have noted that the polyurethane foam formed from the liquid mixture of polyols, the polyol, the surfactant and the possible additive under the conditions of the method of the invention has mechanical properties suitable for use in a seat element.

In particular, the foam's three-dimensional cross-linked network gives it, among other things, mechanical properties suitable for use in a motor vehicle seat element.

The polyol used in step b) of the method of the present invention is of petrochemical or biobased origin. For example, it can be selected from alkoxylated glycerol, alkoxylated sorbitol, alkoxylated diethyl triamine, alkoxylated sucrose, polyoxypropylene glycol-based polyols and mixtures thereof, in particular alkoxylated diethyl triamine, polyoxypropylene glycol-based polyols and mixtures thereof, more particularly polyoxypropylene glycol-based polyols and mixtures thereof.

Caradol SA34-05, Wanol F3135, Lupranol 2095, Lupranol 2090, Nextyol Y-3322N and Rokopol 6010 are examples of commercial polyols suitable for use alone or in admixture as a second polyol in the method of the present invention.

The mass ratio of liquid mixture of polyols: surfactant in step b) can be between 100:1 and 100:10, in particular between 100:3 and 100:5, more particularly 100:5.

Advantageously, such a liquid mixture of polyols: surfactant mass ratio makes it possible to prevent foam collapse during the foaming method.

According to the invention, the surfactant is chosen from an anionic surfactant, a cationic surfactant, a zwitterionic surfactant, a nonionic surfactant and mixtures thereof, more particularly from a nonionic surfactant.

For the purposes of this invention, “non-ionic surfactant” means a surfactant whose lipophilic and hydrophilic parts are uncharged.

For the purposes of this invention, “zwitterionic surfactant” means a surfactant wherein one of the lipophilic and hydrophilic parts is positively charged, while the other is negatively charged.

For the purposes of this invention, “anionic surfactant” means a surfactant containing only anionic groups as ionic or ionizable groups.

For the purposes of this invention, “cationic surfactant” means a surfactant containing only cationic groups as ionic or ionizable groups.

In one embodiment, the non-ionic surfactant can be a silicone surfactant.

For the purposes of this invention, “silicone surfactant” means a non-ionic surfactant comprising at least one silicone atom.

The silicone surfactant can, for example, be selected from polyalkylsiloxane, polyoxyalkylene polyol-modified dimethylpolysiloxane, alkylene glycol-modified dimethylpolysiloxane and mixtures thereof, in particular a mixture of polyalkylsiloxane and polyoxyalkylene polyol-modified dimethylpolysiloxane.

Typically, the polyisocyanate compound may be selected from m-phenylene diisocyanate, toluene 2,4-diisocyanate, toluene 2,6-diisocyanate, hexamethylene 1,6-diisocyanate, 1,4-tetramethylene diisocyanate, cyclohexane 1,4-diisocyanate, hexahydrotoluene diisocyanate, naphthylene 1,5-diisocyanate, methoxyphenyl-2,4-diisocyanate, 4,4′-diphenylmethane diisocyanate and isomers thereof, 4,4′-biphenylene diisocyanate, 3,3′-dimethoxy-4,4′-biphenyl diisocyanate, 3,3′-dimethyl-4,4′-biphenyl diisocyanate, 3,3′-dimethyldiphenylmethane 4,4′-diisocyanate, 4,4′,4″-triphenyl methane triisocyanate, polymethylene polyphenylisocyanate, polymeric diphenylmethane diisocyanate, isophorone diisocyanate, 2,4,6-triisocyanate toluene, 4,4′-dimethyldiphenylmethane-2,2′, 5,5′-tetraisocyanate, polymethylene polyphenyl isocyanate ester and mixtures thereof, in particular toluene 2,4-diisocyanate, toluene 2,6-diisocyanate, hexamethylene 1,6-diisocyanate, 4,4′-diphenylmethane diisocyanate, polymethylene polyphenylisocyanate, polymeric diphenylmethane diisocyanate, isophorone diisocyanate, isocyanic acid polymethylene polyphenyl ester and mixtures thereof, especially 4,4′-diphenylmethane diisocyanate its and isomers, polymethylene polyphenylisocyanate, polymeric diphenylmethane diisocyanate, toluene 2,4-diisocyanate, toluene 2,6-diisocyanate and mixtures thereof, even more particularly polymeric diphenylmethane diisocyanate.

The mass ratio of mixture of liquid mixture of polyols: polyisocyanate compound can be between 1:100 and 45:100, in particular between 3:100 and 35:100, most particularly between 20:100 and 30:100.

In order to modify and/or improve the properties of the polyurethane foam, an additive known to the person skilled in the art can be added during step b) of the method of the present invention. Typically, this additive may be selected from a cross-linking agent, a flame retardant, a blowing agent, an antioxidant, an anti-hydrolysis agent, a biocide and mixtures thereof, in particular selected from a cross-linking agent, a flame retardant, a blowing agent and mixtures thereof, most particularly a cross-linking agent, a blowing agent or mixtures thereof.

For the purposes of this invention, “crosslinking agent” refers to a compound that generates the formation of one or more three-dimensional networks in polyurethane foam. The crosslinking agent can be selected from glycerol, diethanolamine, triethanolamine, glycols with a molecular weight of less than 1000 and a functionality of greater than or equal to 3, and mixtures thereof, in particular diethanolamine, triethanolamine, and mixtures thereof.

For the purposes of the present invention, “flame retardant” means a compound having the property of reducing or preventing the combustion or heating of the materials it impregnates or coats. The flame retardant may, for example, be antimony, graphite, silicate, boron, a compound containing a halogen, nitrogen, or phosphorus such as tris (1-chloro-2-propyl) phosphate (TCPP), triethylene phosphate (TEP), triaryl phosphate ester, ammonium polyphosphate, red phosphorus, trishalogenaryl or mixtures thereof.

For the purposes of the present invention, “blowing agent” refers to a compound that induces expansion of a composition by chemical and/or physical action during a foaming stage. Typically, the chemical blowing agent is selected from water, formic acid, phthalic anhydride, and acetic acid. The physical blowing agent can be selected from pentane and pentane isomers, hydrocarbons, hydrofluorocarbons, hydrochlorofluoroolefins, hydrofluoroolefins (HFOs), ethers and mixtures thereof. An example of an blowing agent of the ether type is methylal. According to the invention, a mixture of chemical and physical blowing agents is, for example, a mixture of water/pentane isomer or formic acid/pentane isomer or water/hydrofluoro-olefins or pentane isomer/methylal/water or water/methylal.

In a particular embodiment, the blowing agent is water.

The polyurethane foam produced by the method of the invention may be molded.

Step c) can therefore be carried out in a mold having a shape suitable for a seat component, in particular a motor vehicle seat, an aircraft seat, a furniture seat, most particularly a motor vehicle seat.
Alternatively, step c) can be carried out in a mold that does not represent a suitable shape for a seat component to produce a molded polyurethane foam, which is then formed into a shape suitable for a seat component.

The polyol, surfactant, polyisocyanate compound and any additive can be pre-mixed and the resulting mixture introduced into the mold.

The mold in which step b) is carried out can be heated. Thus, the reaction step b) can be carried out at a temperature of between 30° C. and 100° C., in particular between 40° C. and 80° C., most particularly between 50° C. and 65° C.

A catalyst can be used to accelerate the kinetics of the reaction between the polyol mixture and the polyisocyanate compound, and potentially, between the polyisocyanate compound and the chemical blowing agent during step b) of the method of the present invention.

Thus, according to one embodiment, step b) of the method of the present invention can be carried out in the presence of a catalyst.

The amount of catalyst used in the polyurethane foam production method depends on the compounds used in the method. The person skilled in the art will know how to adapt this quantity.

Typically, the catalyst can be selected from catalysts known to catalyze expansion (water-isocyanate) and gelation (polyol-isocyanate) reactions. Catalysts are essentially based on primary amines, secondary amines or tertiary amines containing primary hydroxyl, secondary hydroxyl, amide or urea groups.

Examples of such catalysts include at least one item selected from the group consisting of N,N-bis (3-dimethylaminopropyl)-N-(2-hydroxypropyl) amine; N,Ndimethyl-N′,N′-bis (2-hydroxypropyl)-1,3-propylenediamine; dimethylaminopropylamine (DMAPA); N-methyl-N-2-hydroxypropylpiperazine, bis-dimethylaminopropylamine (POLYCAT 15), dimethylaminopropyl urea and N,N′-bis (3-dimethylaminopropyl) (DABCO NE1060, DABCO NE1070, DABCO NE 1080 and DABCO NE 1082), 1,3-bis (dimethylamino)-2-propanol, 6-dimethylamino-1-hexanol, N-(3-aminopropyl) imidazole, N-(2-hydroxypropyl) imidazole, N,N′-bis (2-hydroxypropyl) piperazine, N-(2-hydroxypropyl) morpholine and N-(2-hydroxyethylimidazole). The catalyst compositions may also comprise other components, for example transition metal catalysts such as organotin compounds or bismuth carboxylates.

According to one embodiment, the method of the present invention may comprise, prior to the glycolysis treatment step a), a step of grinding the seat cover material to obtain particles having a diameter between 1 mm and 20 mm, in particular between 3 mm and 10 mm, most particularly between 4 mm and 6 mm, which are implemented in the contact step a).

The particle size can be determined by sieving.

The use of particles with diameters in these ranges facilitates and accelerates depolymerization of the seat cover material.

Typically, this crushing step can be carried out by cryogenics, by crushing with a vibratory ball mill, with a knife mill, with a hammer mill, with a shredder, with a centrifuge, or by pulsed energy, or combinations thereof. These methods are known to the person skilled in the art. That person will know how to select and implement the most suitable method for the cover material to be ground.

The liquid mixture of polyols obtained after step a) may comprise solid impurities such as pieces of foam that have not reacted with the glycol. These solid impurities can affect step c) and thus alter the production method of the polyurethane foam produced.

To alleviate these problems, the method of the present invention may further comprise, between step a) and step b):
a filtration step for the liquid mixture of polyols to obtain a liquid mixture of polyols free of solid particles.

The filtration step is a conventional step known to those skilled in the art. That person knows how to put it into practice.

Amino compounds in the liquid mixture of polyols can impair the implementation of step c) of the method of the present invention.

To alleviate this problem, the method of the present invention may further comprise, between step a) and step b):
a deamination step of the liquid mixture of polyols to obtain a liquid mixture of polyols totally or partially devoid of amino compounds.

According to another aspect, the present invention, which concerns a polyurethane foam for seats, in particular for motor vehicle seats, aircraft seats and furniture seats, is obtainable by the method of the present invention as defined below.

Advantageously, this polyurethane seat foam has properties, in particular density, of the same order of magnitude as an industrial polyurethane foam produced from petrochemical polyols and commonly used in motor vehicle seats. This polyurethane foam can therefore be used in a motor vehicle seat element.

### EXAMPLES

The following examples illustrate the invention without limiting it.

In these examples, measurements are taken to the following standards:
hydroxyl value per ISO 14900:2017, and
density per DIN EN ISO 845 (2006).

In these examples, the foam rise profile is determined according to the

following protocol. The polyol, the polyisocyanate compound, and the additives are mixed and poured into a container for a given time (5s). At the end of this period, a device (Universal Foam Qualification System, FORMAT Messtechnik) measures the expansion height over time.

### Example 1

### Obtaining the Liquid Mixture of Polyols

Flakes of seat cover material produced by cutting, consisting of a polyethylene terephthalate appearance material, a polyurethane slit foam and a polyethylene terephthalate charmeuse with a particle size of less than 6 mm are brought into contact with diethylene glycol to obtain a liquid mixture of polyols by glycolysis treatment.

The liquid mixture of polyols has the following features:
hydroxyl index of 438 mg (KOH)·g⁻¹, and
viscosity of 1160 mPa·s at 25° C.
   As such, it cannot be used in a reaction to produce flexible polyurethane foam, as the hydroxyl value is too high.

### Example 2

### Production of Flexible Molded Polyurethane Foams From the Liquid Mixture of Polyols of Example 1

The liquid mixture of polyols of Example 1 is blended, in different proportions, with a polyol, which is Rokopol 6010 to obtain two blended polyols, polyol 20% and polyol 30%.

In polyol 20%, the mass ratio of liquid polyol:polyol mixture is 20:80.
In polyol 30%, the mass ratio of liquid polyol:polyol mixture is 30:70.

### Example 2a

### Polyol 20%

The rise profile of a foam obtained by mixing 47% by weight of 20% polyol, 0.5% by weight of surfactant (TEGOSTAB® B 8738 LF), 1.7% by weight of water (blowing agent), 0.3% by weight of Jeffcat ZF-10 (catalyst), 0.3% by weight Dabco 33LX (catalyst), 0.5% Dabco NE 1070 (catalyst), 0.4% diethanolamine (crosslinking agent), 1.3% triethanolamine (crosslinking agent), and 48% by weight of an isocyanate compound (ISO 135/161 (BASF)) is determined.

The rise profile of a reference foam suitable for use in a seat element obtained by mixing 47% by weight of Rokopol 6010, 0.5% by weight of surfactant (TEGOSTAB® B 8738 LF), 1.7% by weight of water (blowing agent), 0.3% by weight Jeffcat ZF10 (catalyst), 0.3% by weight Dabco 33LX (catalyst), 0.5% Dabco NE 1070 (catalyst), 0.4% diethanolamine (crosslinking agent), 1.3% triethanolamine (crosslinking agent), and 48% by weight of an isocyanate compound (ISO 135/161 (BASF)), is determined.

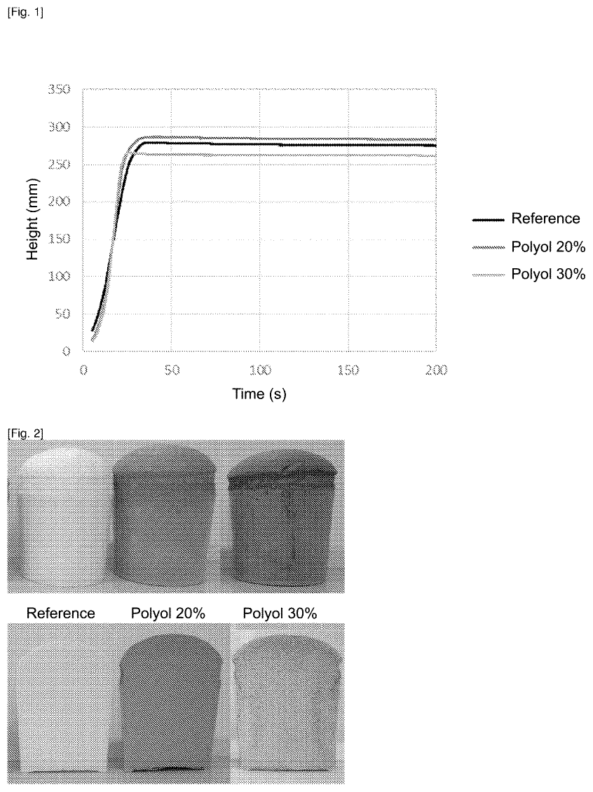

As shown in [FIG. 1] and [FIG. 2], the foam obtained from the polyol 20% has a foam rise profile and structure comparable to the reference foam. The foam obtained from the polyol 20% can therefore be used in a seat element.

### Example 2b

### Polyol 30%

The rise profile of a foam obtained by mixing 47% by weight of 30% polyol, 0.5% by weight of surfactant (TEGOSTAB B 8738 LF), 1.7% by weight of water (blowing agent), 0.3% by weight of Jeffcat ZF-10 (catalyst), 0.3% by weight Dabco 33LX (catalyst), 0.5% Dabco NE 1070 (catalyst), 0.4% diethanolamine (crosslinking agent), 1.3% triethanolamine (crosslinking agent), and 48% by weight of an isocyanate compound (ISO 135/161 (BASF)) is determined.

As shown in [FIG. 1] and [FIG. 2], the foam obtained from the polyol 30% has a foam rise profile and structure comparable to the reference foam. The foam obtained from the polyol 30% can therefore be used in a seat element.

1. A method for producing recycled polyurethane foam comprising the following steps:
a) glycolysis treatment of a seat cover material to obtain a liquid mixture of polyols, and
b) bringing the liquid mixture of polyols, a polyol, a surfactant, a polyisocyanate compound and optionally an additive into contact to produce the recycled polyurethane foam
wherein the seat cover material is selected from the group consisting of polyester, polyurethane foam, polyethylene terephthalate, polyamide and mixtures thereof,
wherein
the mass ratio of liquid mixture of polyols: polyol in step b) is greater than or equal to 1:99 and less than 40:60, and
the surfactant is chosen from the group consisting of an anionic surfactant, a cationic surfactant, a zwitterionic surfactant, a nonionic surfactant and mixtures thereof.

2. The method according to claim 1 wherein the recycled polyurethane foam is for a seat.

3. The method according to claim 1 wherein the recycled polyurethane foam is for a mattress or sofa.

4. The method according to claim 1 wherein the seat cover material comes from all or part of the cover, from a waste product from the production of the cover, from a waste product from the cutting of the cover, from a waste product from the end-of-life of a motor vehicle seat or combinations thereof.

5. The method according to claim 1 wherein the liquid mixture of polyols has:
a hydroxyl value of between 200 mg (KOH)·g⁻¹ and 700 mg (KOH)·g⁻¹, and
a viscosity at 25° C. of between 500 mPa·s and 5000 mPa·s.

6. The method according to claim 1 wherein the polyol is selected from the group consisting of alkoxylated glycerol, alkoxylated sorbitol, alkoxylated diethyl triamine, alkoxylated sucrose, polyoxypropylene glycol-based polyols and mixtures thereof.

7. The method according to claim 1 wherein the surfactant is a silicone surfactant.

8. The method according to claim 1, wherein the mass ratio of mixture of liquid polyols: surfactant is between 100:1 and 100:10.

9. The method according to claim 1 wherein the polyisocyanate compound is selected from the group consisting of m-phenylene diisocyanate, toluene 2,4-diisocyanate, toluene 2,6-diisocyanate, hexamethylene 1,6-diisocyanate, tetramethylene cyclohexane 1,4-diisocyanate, 1,4-diisocyanate, hexahydrotoluene diisocyanate, naphthylene 1,5-diisocyanate, methoxyphenyl-2,4-diisocyanate, diphenylmethane 4,4′-diisocyanate and isomers thereof, 4,4′-biphenylene diisocyanate, 3,3′-dimethoxy-4,4′-biphenyl diisocyanate, 3,3′-dimethyl-4,4′-biphenyl diisocyanate, 3,3′-dimethyldiphenylmethane 4,4′-diisocyanate, 4,4′,4″-triphenyl methane triisocyanate, polymethylene polyphenylisocyanate, polymeric diphenylmethane diisocyanate, isophorone diisocyanate, 2,4,6-triisocyanate toluene, 4,4′-dimethyldiphenylmethane-2,2′,5,5′-tetraisocyanate, isocyanic acid polymethylenepolyphenyl ester and mixtures thereof.

10. The method according to claim 1, wherein the mass ratio of mixture of liquid polyols: polyisocyanate compound is between 100:1 and 45:100.

11. The method according to claim 1 wherein an additive is added in step b).

12. The method according to claim 11 wherein the additive is selected from the group consisting of a crosslinking agent, a flame retardant, a blowing agent, an anti-oxidant, an anti-hydrolysis agent, a biocide, and mixtures thereof.
